(19) United States
(12) Patent Application Publication
(10) Pub. No.: US 2026/0210544 A1
(43) Pub. Date: Jul. 23, 2026

(54) GASEOUS FUEL MIXERS

(71) Applicant: UNITED STATES GYPSUM COMPANY, Chicago, IL (US)

(72) Inventors: Te Hua Lau, Glenview, IL (US); Steven Whirry, Grayslake, IL (US)

(21) Appl. No.: 19/385,632

(22) Filed: Nov. 11, 2025

Related U.S. Application Data
(60) Provisional application No. 63/748,229, filed on Jan. 22, 2025.

(51) Int. Cl. F23D 14/24; B01F 23/10; B01F 25/00; B01F 25/10; B01F 101/00; B28B 11/24; F23D 14/64; F23K 5/00; F27B 9/00; F27D 99/00

(52) U.S. Cl. CPC F23D 14/24; B01F 23/10; B01F 25/103; B01F 25/104; B28B 11/24; F23D 14/64; F23K 5/007; F27D 99/0033; B01F 2025/913; B01F 2101/501; F23C 2900/9901; F23K 2900/05004; F27B 9/00

(57) ABSTRACT

An apparatus for mixing gaseous fuel includes a first conduit configured to receive natural gas from a natural gas supply and including a terminal portion including a side wall and an end wall, a second conduit configured to receive hydrogen gas from a hydrogen gas supply and surrounding at least a portion of the first conduit including the terminal portion, a flow passage extending intermediate the first conduit and the second conduit, a plurality of orifices formed in the terminal portion of the first conduit and configured to provide natural gas flow from the first conduit to the flow passage and a plurality of swirl vanes extending form the side wall of the terminal portion of the first conduit into the flow passage and toward the second conduit and positioned at locations adjacent to the plurality of orifices.

### CROSS-REFERENCE

The present disclosure claims priority to and the benefit of U.S. application Ser. No. 63/748,229 filed Jan. 22, 2005 which is hereby incorporated by reference.

### TECHNICAL FIELD

The present disclosure relates to gaseous fuel mixers and more particularly, but not exclusively, to large or, high-volume gaseous fuel mixers for supplying mixed gaseous fuel to burners of industrial ovens, and to related apparatuses, processes, and systems.

### BACKGROUND

A number of proposals have been made for mixing of gaseous fuels for combustion. Existing proposals suffer from a number of drawbacks, disadvantages, and shortcomings including those respecting efficacy and reliability of mixing at various flow volumes and rates, size and flow distance required for mixing, and difficulty of manufacture, among others. There remains a significant need for the unique apparatuses, processes, and systems of the present disclosure.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention as set forth in the claims following this disclosure includes and protects such alterations, modifications, and further applications of the example embodiments as would occur to one skilled in the art with the benefit of the present disclosure.

### SUMMARY OF THE DISCLOSURE

Some example embodiments include unique gaseous fuel mixers. Some example embodiments include unique processes using gaseous fuel misers. Some example embodiments include unique systems including gaseous fuel mixers. Further embodiments, forms, objects, features, advantages, aspects, and benefits shall become apparent from the following description and drawings.

### BRIEF DESCRIPTION OF THE DRAWINGS

FIG. 1 is a schematic diagram depicting certain aspects of an example industrial oven system.

FIG. 2 is a side, partially axially-sectional view depicting certain aspects of an example gaseous fuel mixer.

FIG. 2A is a sectional view of the example gaseous fuel mixer FIG. 2 taken in the direction of line A—A.

FIG. 2B is an enlarged view of a portion of FIG. 2 indicated by brackets B—B.

FIG. 3 is a sectional view depicting gas flow through the mixer of FIG. 2.

FIG. 4 is a perspective, partially transparent view depicting gas flow through the mixer of FIG. 2.

### DETAILED DESCRIPTION OF EXAMPLE EMBODIMENTS

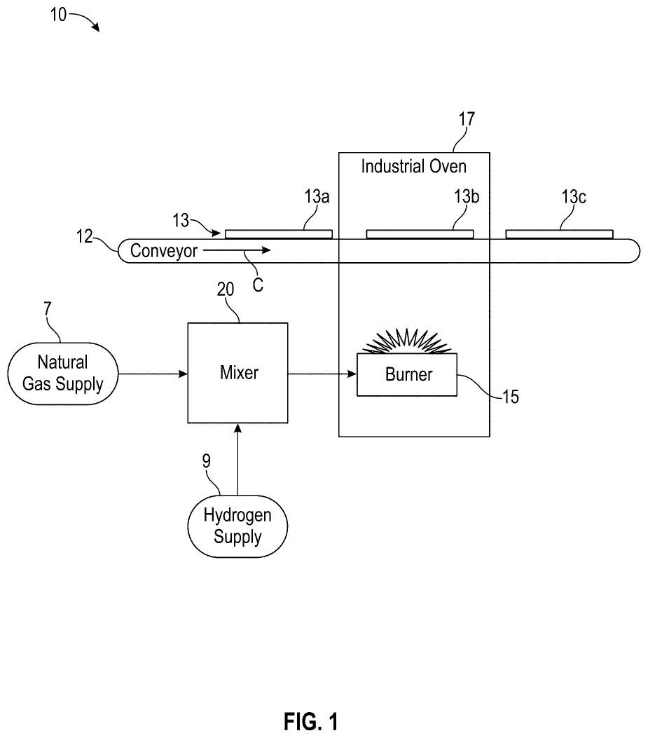

Referring now to the drawings and with initial reference to FIG. 1, there is illustrated an example industrial system 10 (also referred to herein as system 10) including natural gas supply 7, hydrogen gas supply 8, and mixer 20. Mixer 20 is in operative communication with and configured to receive natural gas from natural gas supply 7. Mixer 20 is also in operative communication with and configured to received hydrogen gas from hydrogen gas supply 8. Mixer 20 is further configured and operable to mix the natural gas and hydrogen gas that it receives and to output and supply a mixture of hydrogen gas and natural gas. Industrial oven 17 includes a burner 15 which is in operative communication with mixer 20 and is configured to receive a mixture natural gas and hydrogen gas from mixer 20.

Industrial oven 17 is further configured to receive production articles 13 which are transported through industrial oven 17 by conveyor 12. In the illustrated example, production articles 13 comprise wall board sheets 13a, 13b, 13c. In other embodiments, conveyor 12 may transport other production articles through industrial oven 17, for example, insulation articles, ceiling panel or ceiling tile articles, flooring articles, roofing articles, or other production articles as will occur to one of skill in the art with the benefit and insight of the present disclosure.

Industrial oven 17 is configured to utilize heat from burner 15 to cure wall board sheets 13a, 13b, 13c which are advanced into, through, and out of industrial oven 17 by conveyor 12 in the direction generally indicated by arrow C. In the illustrated state of operation, wall board sheet 13a is a green or uncured article approaching industrial oven 17, wall board sheet 13b is disposed within and is being cured in industrial oven 17, and wall board sheet 13c is a cured article that has exited industrial oven 17.

To adequately supply burner 15, mixer 20 may be configured as a large, high-volume gaseous fuel mixer, although other mixer sizes and volumes are also contemplated. In some forms, burner 15 may be configured and provided as a relatively large burner configured and operable to output 128 M BTU per hour. Other embodiments contemplate burners with other output ratings, for example, greater than or equal to 10 M BTU per hour, greater than or equal to 50 M BTU per hour, greater than or equal to 100 M BTU per hour, or other large burner output ratings as will occur to one of skill in the art with the benefit and insight of the present disclosure.

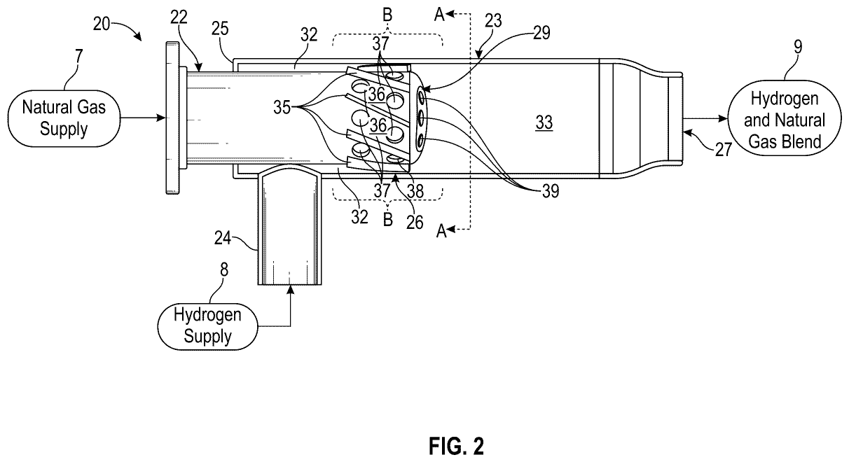

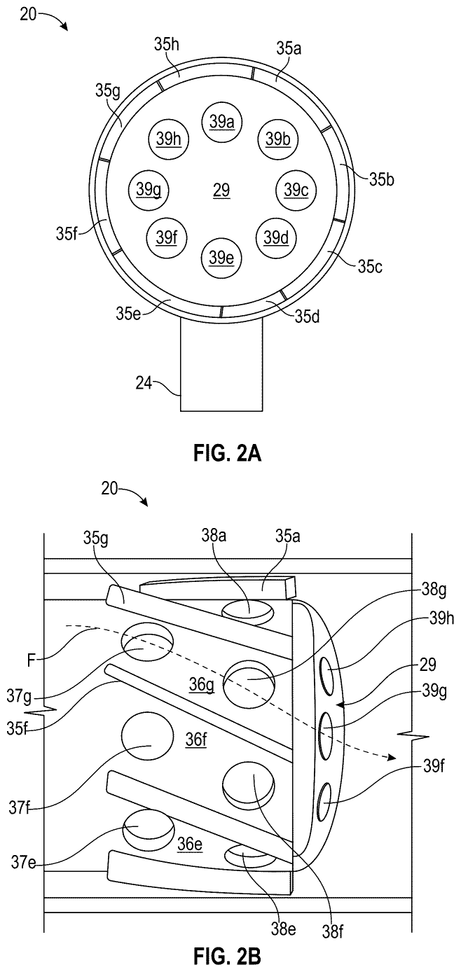

With reference to FIGS. 2, 2A, and 2B there is illustrated an example embodiment of mixer 20. In the illustrated example, mixer 20 includes conduit 22 which is configured to receive natural gas flow from natural gas supply 7 and conduit 23 which is configured to receive hydrogen gas flow from a hydrogen gas supply 8 via a branch conduit 24. In the illustrated example, conduit 22 and conduit 23 are configured and provided as tubular conduits including a generally circular or annular radial cross-sectional shape. It shall be appreciated that other embodiments contemplate other forms of conduit which may including other radial cross-sectional such as conical, cone-shaped, square, rectangular other polygonal, oval, or other shapes as will occur to one of skill in the art with the benefit and insight of the present disclosure.

At least a portion of conduit 22 is surrounded by conduit 23 to define flow passage 32. In this respect, conduit 22 may be considered an example of an inner conduit and conduit 23 may be considered an example of an outer conduit. Flow passage 32 extends intermediate conduit 22 and conduit 23 from a closed end 25 of conduit 23 to terminal portion 26 of conduit 22. Flow passage 32 preferable provides a flow area (e.g., an annular area of the gap intermediate conduit 22 and conduit 23) that is equal to or greater than the area of the outlet of branch conduit 24 as it joins with conduit 22. The outlet of branch conduit 24 is positioned to deliver and introduce hydrogen gas at a location along the length of conduit 22 upstream of a plurality of swirl vanes 35 and a plurality of orifices 37, 38, 39. Such positioning may promote circulation and distribution of hydrogen gas about the periphery of conduit 22 prior to the flow encountering the plurality of swirl vanes 35 and/or the plurality of orifices 37, 38, 39.

Tubular conduit 23 extends past terminal portion 26 of conduit 22 to an outlet 27 of conduit 23 providing mixing chamber 33 in this this region. Mixing chamber 33 is bounded by conduit 23 and extends downstream from terminal portion 26 of conduit 22 to outlet 27 of conduit 23. In the illustrated example, mixing chamber 33 comprises a length to diameter ratio equal to or greater than 3:1. Such a ratio promotes homogeneous or substantially homogeneous mixing of natural gas supplied via conduit 22 with hydrogen gas supplied via conduit 23. Preferably mixing chamber 33 may have a length to diameter ratio of about 3:1 (e.g. 3:1+5% or 3:1+/−5 %) to promote homogenous mixing and inhibit stratification.

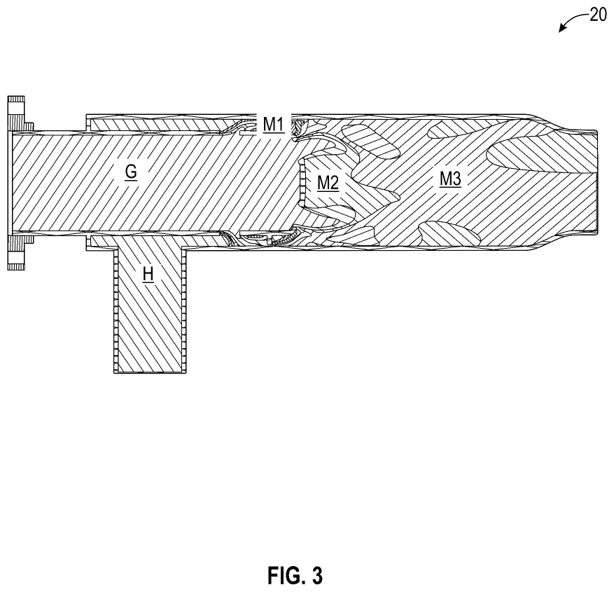

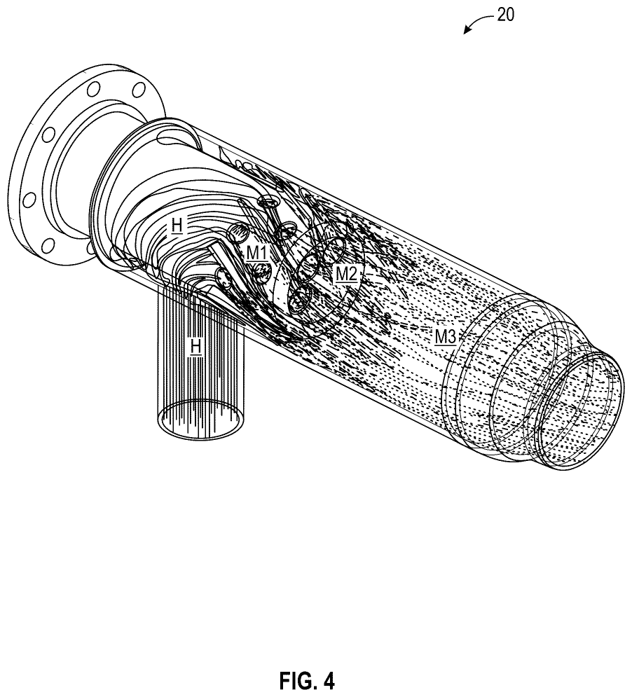

A plurality of orifices 37, 38, 39 are formed in terminal portion 26 of conduit 22 and are configured to provide natural gas flow from the conduit 22 to flow passage 32. A plurality of swirl vanes 35 extending from conduit 22 into flow passage 32 and toward conduit 23. A small gap (e.g., one sixteenth of an inch) may be provided between radial extremities of the plurality of swirl vanes 35 and the inner surface of conduit 23 and may promote mixing of mixing of natural gas flow and hydrogen gas flow, for example, by prompting flow separation and turbulence. The plurality of swirl vanes 35 are positioned adjacent to the plurality of orifices 37, 38, 39. The plurality of orifices 37, 38, 39 and the plurality of swirl vanes 35 are configured to provide turbulent mixing of natural gas flow and hydrogen gas flow, for example, as further described in connection with FIGS. 3 and 4.

In the illustrated example, the plurality of orifices 37, 38, 39 comprises a first plurality of orifices 37, 38 formed in a side wall of terminal portion 26 of conduit 22 and a second plurality of orifices 39 formed in an end wall 29 of terminal portion 26 of conduit 22. In the illustrated example, the first plurality of orifices 37, 38 are provided in rows or circumferential rings adjacent from one another with a rotational offset of orifices. The second plurality of orifices 39 includes orifices 39a-39g which are positioned in a ring about the periphery of end wall 29. Second plurality of orifices 39 are preferably formed at an angle oriented to direct flow through the second orifice toward a respective helical flow path. Such angled orientation may be provided by drilling orifices 39 into end wall 29 at a desired angle. End wall 29 comprises a dome-shaped outer surface. The curvature of the dome-shaped outer surface and the positioning of each second orifice thereon may also be selected to contribute to the orientation directing flow through each second orifice toward a respective helical flow path.

The total area of the plurality of orifices 37, 38, 39 is preferably equal to or greater than the radial cross-sectional area of conduit 22. Such relative sizing may be utilized to avoid flow restriction and minimizing pressure drop of natural gas flowing through conduit 22 and through the plurality of orifices 37, 38, 39 into flow passage 32. In the illustrated example, the first plurality of orifices 37, 38 comprises sixteen orifices formed in two rows each comprising eight orifices. Other embodiments may utilize different numbers and different arrangements of a first plurality of orifices. In the illustrated example, the second plurality of orifices 39 comprises 8 formed one ring. Other embodiments may utilize different numbers and arrangements of a second plurality of orifices.

In the illustrated example, plurality of swirl vanes 35 comprise eight swirl vanes 35a-35g which are arranged in a helical distribution about the outer surface of conduit 22. Other embodiments may utilize different numbers and arrangements of swirl vanes.

The plurality of swirl vanes 35 define a plurality of helical flow paths 36 in flow passage 32 extending lengthwise along flow passage 32. Each of the plurality of helical flow paths are configured to direct flow toward a respective subset of the plurality of orifices plurality of orifices 37, 38, 39. FIG. 2B illustrates an example helical flow path generally indicated by arrow F bounded by swirl vane 35g and swirl vane 35f.

In the illustrated example, each of the respective subsets of the plurality of helical flow paths 36 includes at least one orifice formed in a side wall of terminal portion 26 conduit 22 and at least one orifice formed in end wall 29 of terminal portion 26 of conduit 22. Thus, for example, the helical flow path generally indicated by arrow F include orifice 37g, orifice 38g, and orifice 39g. In other embodiments, the helical flow paths may include different numbers and arrangements of orifices.

With reference to FIGS. 3 and 4, there is illustrated a computational fluid dynamics (CFD) model flow analysis for mixer 20. In FIGS. 3 and 4, shaded flow region G indicates natural gas flow, shaded flow region H indicates hydrogen gas flow, shaded regions M1, M2, M3 indicate mixed natural gas and hydrogen gas flow at generally increasing degrees of homogeneity and generally decreasing degrees of stratification. Turbulent flow may be present in regions M1 and may further increase in region M2 and persist into region M3.

As illustrated by this detailed description the present disclosure contemplates a plurality of embodiments including the following example embodiments.

Example embodiment 1 is an apparatus for mixing gaseous fuel, the apparatus comprising: a first conduit configured to receive natural gas from a natural gas supply and including a terminal portion including a side wall and an end wall; a second conduit configured to receive hydrogen gas from a hydrogen gas supply and surrounding at least a portion of the first conduit including the terminal portion; a flow passage extending intermediate the first conduit and the second conduit; a plurality of orifices formed in the terminal portion of the first conduit and configured to provide natural gas flow from the first conduit to the flow passage; and a plurality of swirl vanes extending form the side wall of the terminal portion of the first conduit into the flow passage and toward the second conduit and positioned at locations adjacent to the plurality of orifices; wherein the plurality of orifices and the plurality of swirl vanes are configured to provide turbulent mixing of natural gas flow and hydrogen gas flow and output a mixture of natural gas and hydrogen gas.

Example embodiment 2 includes the features of example embodiment 1, wherein the plurality of orifices comprises a first plurality of orifices formed in a side wall of the terminal portion of the first conduit and a second plurality of orifices formed in an end wall of the terminal portion of the first conduit.

Example embodiment 3 includes the features of example embodiment 1, wherein a total area of the plurality of orifices is equal to or greater than a radial cross-sectional area of first conduit.

Example embodiment 4 includes the features of example embodiment 1, wherein the plurality of swirl vanes defines a plurality of helical flow paths extending lengthwise along the flow passage.

Example embodiment 5 includes the features of example embodiment 4, wherein the plurality of helical flow paths is configured to direct flow toward respective subsets of the plurality of orifices.

Example embodiment 6 includes the features of example embodiment 5, wherein each of the respective subsets of the plurality of helical flow paths includes a first orifice formed in a side wall of the terminal portion of the first conduit a second orifice formed in an end wall of the terminal portion of the first conduit.

Example embodiment 7 includes the features of example embodiment 6, wherein the second orifice is formed at an angle oriented to direct flow through the second orifice toward a respective helical flow path.

Example embodiment 8 includes the features of example embodiment 6, wherein the end wall comprises a dome-shaped outer surface.

Example embodiment 9 includes the features of example embodiment 4, wherein the plurality of swirl vanes are spaced apart from an interior surface of the second conduit by a gap configured to allow a portion of hydrogen gas to bypass the plurality of swirl vanes and promote mixing of hydrogen gas and natural gas.

Example embodiment 10 includes the features of example embodiment 1, wherein a mixing chamber is bounded by the second conduit and extends downstream from the terminal portion of the first conduit to an outlet of the second conduit.

Example embodiment 11 includes the features of example embodiment 10, wherein the mixing chamber comprises a length to diameter ratio equal to or greater than 3:1.

Example embodiment 12 is a system for combusting a mixture of gaseous fuels, the system comprising: a gaseous fuel mixer including a first conduit configured to receive natural gas from a natural gas supply and including a terminal portion including a side wall and an end wall, a second conduit configured to receive hydrogen gas from a hydrogen gas supply and surrounding at least a portion of the first conduit including the terminal portion, a flow passage extending intermediate the first conduit and the second conduit, a plurality of orifices formed in the terminal portion of the first conduit and configured to provide natural gas flow from the first conduit to the flow passage, and a plurality of swirl vanes extending form the side wall of the terminal portion of the first conduit into the flow passage and toward the second conduit and positioned at locations adjacent to the plurality of orifices, the plurality of orifices and the plurality of swirl vanes are configured to provide turbulent mixing of natural gas flow and hydrogen gas flow and output a mixture of natural gas and hydrogen gas; and an industrial oven including a burner configured to receive the mixture of natural gas and hydrogen gas output by the mixer and combust the mixture to heat cure an uncured article introduced into the industrial oven.

Example embodiment 13 includes the features of example embodiment 12, wherein the plurality of orifices comprises a first plurality of orifices formed in a side wall of the terminal portion of the first conduit and a second plurality of orifices formed in an end wall of the terminal portion of the first conduit.

Example embodiment 14 includes the features of example embodiment 12, wherein a total area of the plurality of orifices is equal to or greater than a radial cross-sectional area of first conduit.

Example embodiment 15 includes the features of example embodiment 12, wherein the plurality of swirl vanes defines a plurality of helical flow paths extending lengthwise along the flow passage.

Example embodiment 16 includes the features of example embodiment 15, wherein the plurality of helical flow paths is configured to direct flow toward respective subsets of the plurality of orifices.

Example embodiment 17 includes the features of example embodiment 16, wherein each of the respective subsets of the plurality of helical flow paths includes a first orifice formed in a side wall of the terminal portion of the first conduit a second orifice formed in an end wall of the terminal portion of the first conduit.

Example embodiment 18 includes the features of example embodiment 17, wherein the second orifice is formed at an angle oriented to direct flow through the second orifice toward a respective helical flow path.

Example embodiment 19 includes the features of example embodiment 15, wherein the plurality of swirl vanes are spaced apart from an interior surface of the second conduit by a gap configured to allow a portion of hydrogen gas to bypass the plurality of swirl vanes and promote mixing of hydrogen gas and natural gas.

Example embodiment 20 includes the features of example embodiment 12, wherein a mixing chamber is bounded by the second conduit and extends downstream from the terminal portion of the first conduit to an outlet of the second conduit.

Example embodiment 21 is a method comprising: operating a system according to any one of example embodiments 12 through 20 combust the mixture to heat cure an uncured article introduced into the industrial oven.

Example embodiment 22 includes the features of example embodiment 21, comprising mixing natural gas and hydrogen gas with the gaseous fuel mixer.

Example embodiment 23 includes the features of example embodiment 22, comprising combusting the mixture with the burner.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise indicated. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language herein, is intended merely to better illuminate the invention and does not pose a limitation on the scope of the invention unless otherwise claimed. No language in the specification should be construed as indicating any non-claimed element as essential to the practice of the invention. When the language “at least a portion” and/or “a portion” is used the item can include a portion and/or the entire item unless specifically stated to the contrary. Furthermore, use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow.

What is claimed is:

1. An apparatus for mixing gaseous fuel, the apparatus comprising:
a first conduit configured to receive natural gas from a natural gas supply and including a terminal portion including a side wall and an end wall;
a second conduit configured to receive hydrogen gas from a hydrogen gas supply and surrounding at least a portion of the first conduit including the terminal portion;
a flow passage extending intermediate the first conduit and the second conduit;
a plurality of orifices formed in the terminal portion of the first conduit and configured to provide natural gas flow from the first conduit to the flow passage; and
a plurality of swirl vanes extending form the side wall of the terminal portion of the first conduit into the flow passage and toward the second conduit and positioned at locations adjacent to the plurality of orifices;
wherein the plurality of orifices and the plurality of swirl vanes are configured to provide turbulent mixing of natural gas flow and hydrogen gas flow and output a mixture of natural gas and hydrogen gas.

2. The apparatus of claim 1, wherein the plurality of orifices comprises a first plurality of orifices formed in a side wall of the terminal portion of the first conduit and a second plurality of orifices formed in an end wall of the terminal portion of the first conduit.

3. The apparatus of claim 1, wherein a total area of the plurality of orifices is equal to or greater than a radial cross-sectional area of first conduit.

4. The apparatus of claim 1, wherein the plurality of swirl vanes defines a plurality of helical flow paths extending lengthwise along the flow passage.

5. The apparatus of claim 4, wherein the plurality of helical flow paths is configured to direct flow toward respective subsets of the plurality of orifices.

6. The apparatus of claim 5, wherein each of the respective subsets of the plurality of helical flow paths includes a first orifice formed in a side wall of the terminal portion of the first conduit a second orifice formed in an end wall of the terminal portion of the first conduit.

7. The apparatus of claim 6, wherein the second orifice is formed at an angle oriented to direct flow through the second orifice toward a respective helical flow path.

8. The apparatus of claim 6, wherein the end wall comprises a dome-shaped outer surface.

9. The apparatus of claim 4, wherein the plurality of swirl vanes are spaced apart from an interior surface of the second conduit by a gap configured to allow a portion of hydrogen gas to bypass the plurality of swirl vanes and promote mixing of hydrogen gas and natural gas.

10. The apparatus of claim 1, wherein a mixing chamber is bounded by the second conduit and extends downstream from the terminal portion of the first conduit to an outlet of the second conduit.

11. The apparatus of claim 10, wherein the mixing chamber comprises a length to diameter ratio equal to or greater than 3:1.

12. A system for combusting a mixture of gaseous fuels, the system comprising:
a gaseous fuel mixer including
a first conduit configured to receive natural gas from a natural gas supply and including a terminal portion including a side wall and an end wall,
a second conduit configured to receive hydrogen gas from a hydrogen gas supply and surrounding at least a portion of the first conduit including the terminal portion,
a flow passage extending intermediate the first conduit and the second conduit;
a plurality of orifices formed in the terminal portion of the first conduit and configured to provide natural gas flow from the first conduit to the flow passage, and
a plurality of swirl vanes extending form the side wall of the terminal portion of the first conduit into the flow passage and toward the second conduit and positioned at locations adjacent to the plurality of orifices, the plurality of orifices and the plurality of swirl vanes are configured to provide turbulent mixing of natural gas flow and hydrogen gas flow and output a mixture of natural gas and hydrogen gas; and
an industrial oven including a burner configured to receive the mixture of natural gas and hydrogen gas output by the mixer and combust the mixture to heat cure an uncured article introduced into the industrial oven.

13. The system of claim 12, wherein the plurality of orifices comprises a first plurality of orifices formed in a side wall of the terminal portion of the first conduit and a second plurality of orifices formed in an end wall of the terminal portion of the first conduit.

14. The system of claim 12, wherein a total area of the plurality of orifices is equal to or greater than a radial cross-sectional area of first conduit.

15. The system of claim 12, wherein the plurality of swirl vanes defines a plurality of helical flow paths extending lengthwise along the flow passage.

16. The system of claim 15, wherein the plurality of helical flow paths is configured to direct flow toward respective subsets of the plurality of orifices.

17. The system of claim 16, wherein each of the respective subsets of the plurality of helical flow paths includes a first orifice formed in a side wall of the terminal portion of the first conduit a second orifice formed in an end wall of the terminal portion of the first conduit.

18. The system of claim 17, wherein the second orifice is formed at an angle oriented to direct flow through the second orifice toward a respective helical flow path.

19. The system of claim 15, wherein the plurality of swirl vanes are spaced apart from an interior surface of the second conduit by a gap configured to allow a portion of hydrogen gas to bypass the plurality of swirl vanes and promote mixing of hydrogen gas and natural gas.

20. The system of claim 12, wherein a mixing chamber is bounded by the second conduit and extends downstream from the terminal portion of the first conduit to an outlet of the second conduit.
